(19) United States
(12) Patent Application Publication
(10) Pub. No.: US 2016/0184920 A1
(43) Pub. Date: Jun. 30, 2016

(54) WHEEL STRUCTURE AND METHOD FOR MAKING THE SAME

(71) Applicant: KING HWA SIN INDUSTRIAL CO., LTD., Tainan City (TW)

(72) Inventor: MING-LIANG LIN, TAINAN CITY (TW)

(21) Appl. No.: 14/583,942

(22) Filed: Dec. 29, 2014

(51) Int. Cl. B23K 20/12; B23K 31/02

(52) U.S. Cl. CPC B23K 20/129; B23K 20/1265; B23K 31/02

(57) ABSTRACT

A wheel structure and a method for making the same are disclosed. The wheel structure comprises at least two components connected together. The connection between the two components is fixed by friction stir welding so as to form a wheel. One of the two components is a hub and the other component is a rim. The rim is made of an aluminum sheet by a spin-forming process to enhance its mechanical strength, and the hub is made by a casting process so as to form hubs with different designs. Moreover, the colors of the rim and the hub are different. Therefore, the wheel structure of the present invention has well mechanical strength and robustness and a gorgeous design so as to promote the competitiveness of the wheel structure of the present invention.

### BACKGROUND OF THE INVENTION

1. Field of the Invention

The present invention relates a wheel structure and method for making the same. More particularly, a wheel is formed by at least two components connected and fixed together by friction stir welding so as to enhance its mechanical strength, robustness, and the degree of gorgeous modeling.

2. Description of Related Art

The wheel of a vehicle such as a car or a motorcycle is composed of a central hub connected with an outer rim. The present wheel of the vehicle such as a car or a motorcycle is made by a casting process, a forging process, or a punching process. In the casting process, an aluminum ingot is melted at 680° C. and the melted aluminum is injected into a mould and casted under the gravity, low pressure, or high pressure to integrally form a wheel composed of the central hub and the outer rim. After casting, the wheel is subsequent processed for tolerance adjustment and abrasive. The casting process is beneficial to mass production and the diversity of the wheel design; however, the process for melting aluminum ingot is quite energy-intensive. Besides, the working time is increased due to subsequent process and the cost of casting mould is great expense. Furthermore, the interior structure of the wheel made by casting has many pores and the mechanical strength of the wheel made by casting is poor, when encountering traffic vibrations or impact, the casted wheel is damaged easily to cause dangers of driving.

The rim is made by the punching process and the punching process is difficult to manipulate. Besides, the attrition rate of the mould used in the punching process is high and the design of the rim is limited so as to make the rim with simple shape. Moreover, although the iron rim has well vibration proof performance and impact resistance, it is too heavier to increase the weight of vehicle so as to increase the fuel consumption. In addition, in the forging process, an aluminum block is made into a rim through several forging procedures. The wheel forged from aluminum block has well mechanical strength and is in lightweight. However, the process for forging the wheels form the aluminum block comprises a number of forging procedures, it requires plenty of time and takes a lot of work as well as the forging process are energy-intensive. Furthermore, the wheel design is also limited in forging process.

Therefore, some people in wheel industry make the central hub and the outer rim respectively and then assemble the central hub with the outer rim by welding, screwing, or riveting. However, when the central hub and the outer rim are joined by welding, due to the obstruction of the coating on the hub and the rim, it is difficult to weld so as to result in unstable connection between the hub and the rim. In addition, if the hub and the rim are joined by screwing or riveting, it is necessary to bore a hole through the hub and the rim for screwing or riveting. However, when driving on the road, the wheel is usually vibrated and impacted due to pass by a rugged road to result in the rivet or the screw loosing to affect the driving safety.

### SUMMARY OF THE INVENTION

Therefore, the object of the present invention is to provide a wheel formed by at least two components connected and fixed together by friction stir welding so as to enhance its mechanical strength, robustness, and the degree of gorgeous modeling.

For the above object, a wheel structure and a method for making the same are disclosed. The wheel structure comprises at least two components connected together. The connection between the two components is fixed by friction stir welding so as to form a wheel. One of the two components is a hub and the other component is a rim. The rim is made of an aluminum sheet by a spin-forming process to enhance its mechanical strength, and the hub is made by a casting process so as to form hubs with different shape. Moreover, the colors of the rim and the hub are different. Therefore, the wheel structure of the present invention has well mechanical strength and robustness, and a gorgeous design so as to promote the competitiveness of the wheel structure of the present invention.

According to the embodiment, a method for making a wheel comprises the steps of making at least two components of the wheel, connecting the at least two components of the wheel, and fixedly connecting the at least two components by friction stir welding for assembling the wheel.

According to another embodiment, a method for making a wheel comprises the steps of making a hub, making a rim, and fixedly connecting the hub and the rim of the wheel by friction stir welding for assembling the wheel.

According to another embodiment, a method for making a wheel comprises the following steps of preparing at least two partial hubs and at least two partial rims, wherein the at least two partial hubs and the at least two partial rims are casted and integrally formed; connecting the at least two partial hubs and the at least two partial rims together and arranging the same into a wheel; and fixedly connecting the at least two partial hubs and the at least two partial rims of the wheel together by friction stir welding for assembling the wheel.

### BRIEF DESCRIPTION OF THE DRAWINGS

FIG. 1 is a flow chart of a method for making a wheel according to the first embodiment of the present invention;

FIG. 2 is a flow chart of a method for making a wheel according to the second embodiment of the present invention;

FIG. 3 is an exploded view of a wheel structure according to the embodiment of the present invention;

FIG. 4 is a perspective view of a wheel structure according to the first embodiment of the present invention;

FIG. 5 is a perspective view of a wheel structure according to the second embodiment of the present invention; and

FIG. 6 is a flow chart of a method for making a wheel according to third embodiment of the present invention.

### DETAILED DESCRIPTION OF THE PREFERRED EMBODIMENT

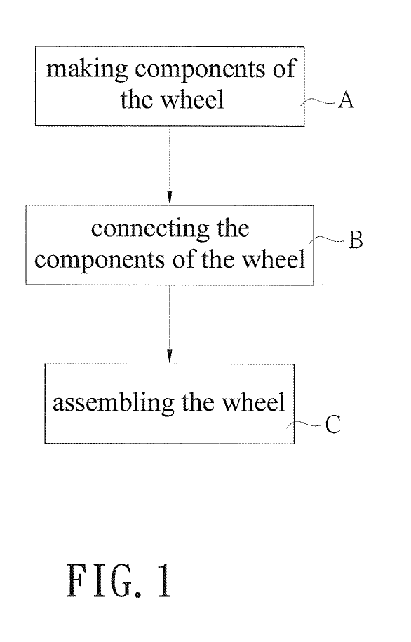

Please refer to FIG. 1, which is a flow chart of a method for making a wheel according to the first embodiment of the present invention. The method comprises the steps of:
A. making at least two components of the wheel;
B. connecting the at least two components of the wheel; and
C. fixedly connecting the at least two components by friction stir welding for assembling the wheel.

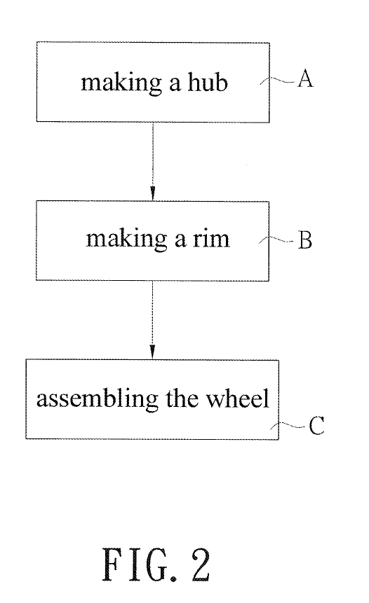

Please refer to FIG. 2, which is a flow chart of a method for making a wheel according to the second embodiment of the present invention. The steps of the method for making the wheel are described below.

A. Make the Hub

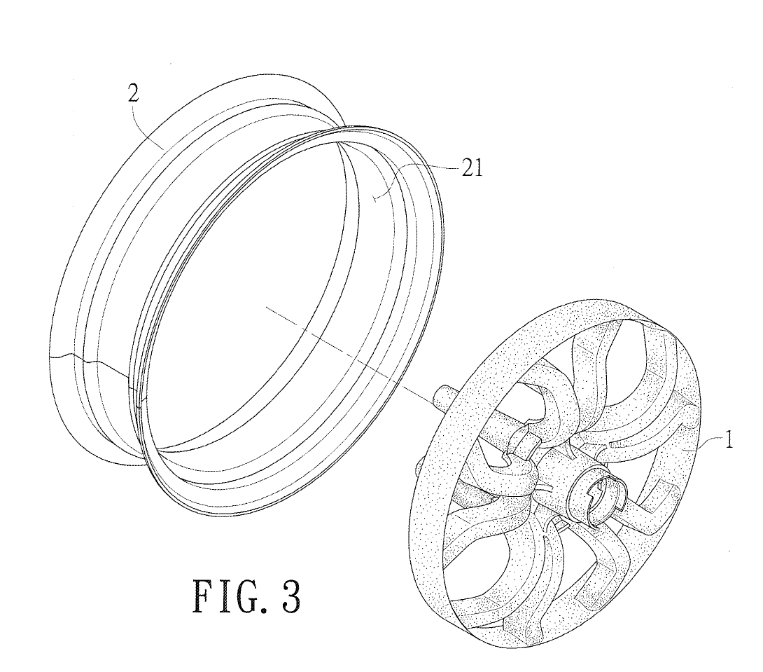

Please refer to FIG. 3. FIG. 3 is an exploded view of a wheel structure according to the embodiment of the present invention. First, aluminum alloy is melted, and then the melted aluminum alloy is injected into a mould to form a hub 1 of the wheel by die casting under the gravity, low pressure, or high pressure. After the hub is made, the hub 1 is painted by a painting step.

B. Make the Rim

A calendered and forged aluminum sheet is made into a circular frame by spin-forming process. Then, the connection between the two ends of the circular frame is fixed by friction stir welding or fusion welding process to form a rim 2. After the rim is made, the rim 2 is treated by an anodic process.

C. Assembly of the Wheel

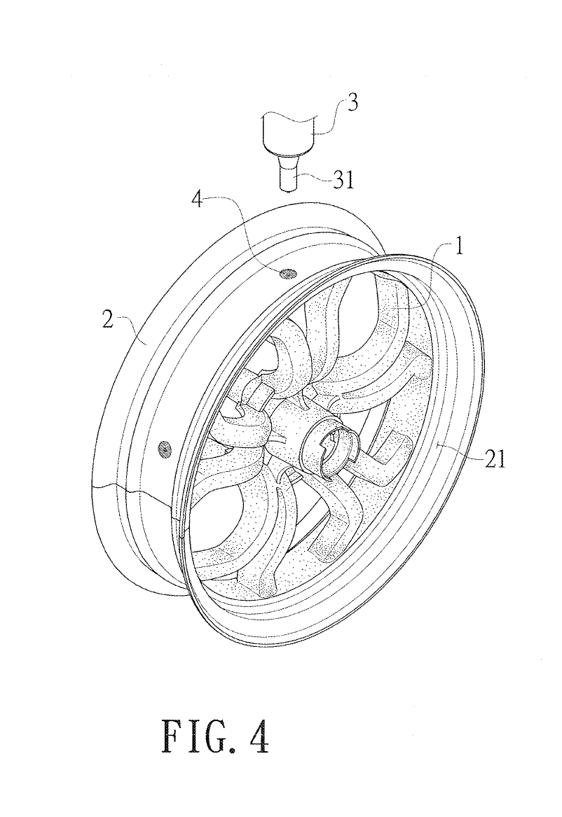

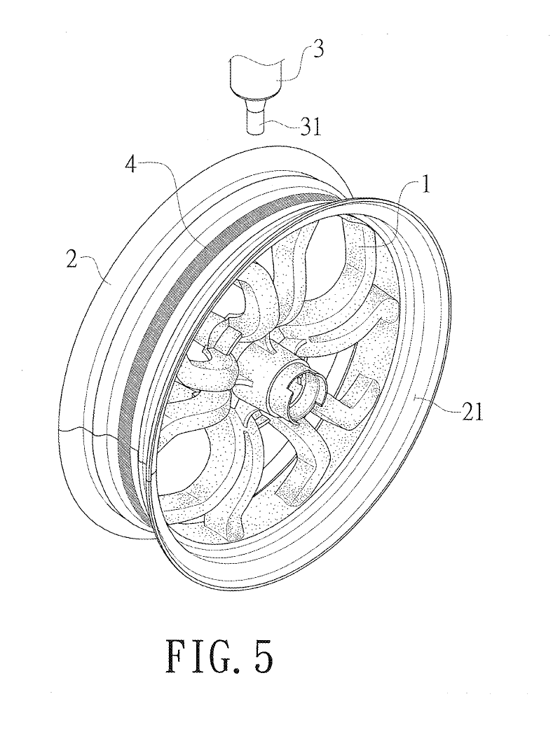

Please refer to FIG. 4, which is a perspective view of a wheel structure according to the first embodiment of the present invention. The hub 1 is set into a central hole 21 of the rim 2 for that the edge of the hub 1 is contacted with the wall of the central hole 21 of the rim 2, and then the edge of the hub 1 is joined to the rim 2 by friction stir welding. In detail, a pin 31 of a high-speed rotation rod 3 is inserted into the inside of the rim 2 from the outside wall of the rim 2 and then inserted into the edge of the hub 1 contacted with the rim 2. When the pin 31 of the rotation rod 3 is stirred and inserted into the edge of the hub 1 contacted with the rim 2, the frictional heat is generated to soften the rim 2 and the edge of the hub 1 so as to fuse the soften material of the rim 2 and the edge of the hub 1 together thereby tightly fixing the rim 2 and the edge of the hub 1 to form a wheel. The rim 2 and the hub 1 are fixedly connected by friction stir welding in dots (shown as FIG. 4) or in line around the rim and the hub (shown as FIG. 5).

Accordingly, the wheel structure with different color combination and gorgeous appearance is formed, in which the hub 1 is in the center of the wheel and the rim 2 is connected around the hub 1, furthermore, the connection between the hub 1 and the rim 2 has dot imprint or line imprint 4 (shown as FIG. 4 and FIG. 5). Because the rim 2 of the wheel structure in the present invention is made from a calendered and forged aluminum sheet by spin-forming process, the interior structure of the rim 2 is compact and has well mechanical strength, well vibration proof performance and impact resistance. Therefore, when a vehicle such as a car or a motorcycle, which is assembled with the wheel of the present invention, passes by a rugged road, it can absorb impact or vibration by the wheel, which has well mechanical strength, to prevent the wheel from deformation and splintering thereby effectively improving the driving safety.

Moreover, the hub 1 of the present invention is formed by casting, so it is convenient to form hubs with different design. In addition, the surfaces of the hub 1 and the rim 2 are treated by a painting step and an anodic process respectively, so the appearance of the wheel of the present invention has gorgeous and different color combination. Therefore, the wheel of the present invention is attractive to consumers, who like new and gorgeous goods, so as to increase the sales rate. Furthermore, the hub 1 and the rim 2 of the wheel of the present invention is made of aluminum alloy, so the wheel is light weight, when it is assembled in the vehicle such as a car or a motorcycle, it does not increase excess weight on the vehicle so as to save the fuel consumption. By the method for making the wheel structure of the present invention, when the hub 1 and the rim 2 are assembled together, the coating does not cause the impediment so that the hub 1 and the rim 2 could be stably welded together. Because the hub 1 and the rim 2 is not joined by riveting or screwing, the disconnection between the hub 1 and the rim 2 resulted from the rivet or the screw loosing due to pass by a rugged road is prevented, and the driving safety is further improved.

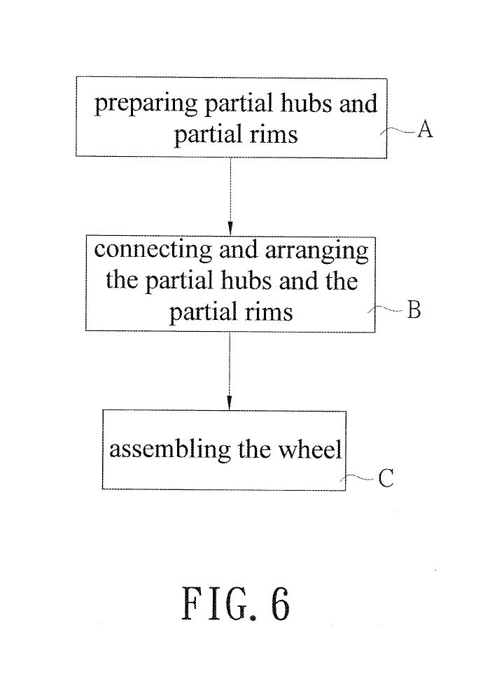

The foregoing embodiments and drawings do not limits the product structures or uses of the present invention. Please refer to FIG. 6, which shows a flow chart of a method for making a wheel according to the third embodiment of the present invention. The method comprises the steps of:

A. preparing at least two partial hubs 1 and at least two partial rims 2, wherein the at least two partial hubs 1 and the at least two partial rims 2 are casted and integrally formed a quarter or a half part of a wheel;

B. connecting the at least two partial hubs 1 and the at least two partial rims 2 together and arranging the same into a wheel; and

C. fixedly connecting the at least two partial hubs 1 and the at least two partial rims 2 of the wheel together by friction stir welding for assembling the wheel.

Accordingly, the volume weight and the cost of the mould and the space for storing the mould are decreased. In addition, the hub 1 is not limited to be made by a casting process; it is made by a forging process or a punching process according to other embodiments of the present invention. Moreover, the materials of the hub 1 and the rim 2 are not limited to aluminum alloy; the hub 1 and the rim 2 are made of different materials according to an embodiment of the present invention.

According to the above description and embodiments, the wheel structure and the method for making the same in the present invention have the advantages as following:

1. At least two components for assembly of the wheel are connected together by friction stir welding in the present invention, in which the rim of the wheel is made of a calendered and forged aluminum sheet by spin-forming process, so the rim has well mechanical strength to prevent the wheel from damage such as deformation to improve the driving safety.

2. At least two components for assembly of the wheel are connected together by friction stir welding in the present invention, in which the rim is made of an aluminum sheet by spin-forming process and the hub is made by casting, so it is convenient to form hubs with different designs. Therefore, the appearance of the wheel of the present invention has gorgeous and different color combination so as to attract the consumer to buying to promote the competitiveness of the wheel structure of the present invention.

3. At least two components for assembly of the wheel are connected together by friction stir welding in the present invention, accordingly, when the two components are assembled together, the coating does not cause the impediment. Because the hub and the rim are not joined by riveting or screwing, the disconnection between the two components resulted from the rivet or the screw loosing due to pass by a rugged road is prevented so as to improve the driving safety.

4. At least two components for assembly of the wheel are connected together by friction stir welding in the present invention, accordingly, the partial hub and the partial rim are integrally formed to a quarter part or a half part of the wheel, and then the quarter parts or half parts of the wheel are arranged and fixed to form a wheel by friction stir welding, thereby saving the cost of the mould and the space for storing the mould.

What is claimed is:

1. A method for making a wheel, comprising the steps of:
A. making at least two components of the wheel;
B. connecting the at least two components of the wheel; and
C. fixedly connecting the at least two components by friction stir welding for assembling the wheel.

2. The method for making a wheel according to claim 1, wherein the friction stir welding for fixing the at least two components is a dot welding or a line welding.

3. A method for making a wheel, comprising the steps of:
A. making a hub;
B. making a rim; and
C. fixedly connecting the hub and the rim of the wheel by friction stir welding for assembling the wheel.

4. The method for making a wheel according to claim 3, wherein the hub is made by a casting process, a forging process, or a punching process.

5. The method for making a wheel according to claim 3, further comprising a painting step for painting the hub after the hub is made.

6. The method for making a wheel according to claim 3, wherein the rim is made of a sheet by a spin-forming process.

7. The method for making a wheel according to claim 6, wherein the sheet is made into a circular frame by a spinning process and the two ends of the circular frame is fixedly connected by friction stir welding.

8. The method for making a wheel according to claim 3, further comprising a step that the rim is treated by an anodic process after being made.

9. The method for making a wheel according to claim 3, wherein the color of the hub is different from the color of the rim.

10. The method for making a wheel according to claim 3, wherein the material of the hub is the same with the material of the rim.

11. The method for making a wheel according to claim 3, wherein the material of the hub is different from the material of the rim.

12. The method for making a wheel according to claim 3, wherein the friction stir welding for fixing the hub and the rim is a dot welding or a line welding.

13. The method for making a wheel according to claim 3, wherein the wheel is made of aluminum alloy.

14. A method for making a wheel, comprising the steps of:
A. preparing at least two partial hubs and at least two partial rims, wherein the at least two partial hubs and the at least two partial rims are casted and integrally formed;
B. connecting the at least two partial hubs and the at least two partial rims together and arranging the same into a wheel; and
C. fixedly connecting the at least two partial hubs and the at least two partial rims of the wheel together by friction stir welding for assembling the wheel.

15. The method for making a wheel according to claim 14, wherein the friction stir welding for fixing the partial hubs and the partial rims is a dot welding or a line welding.
